(19) United States
(12) Patent Application Publication
(10) Pub. No.: US 2011/0025920 A1
(43) Pub. Date: Feb. 3, 2011

(54) SYSTEM FOR CONTROLLING A HOST COMPUTER BY A PORTABLE COMPUTER

(75) Inventor: Ching-Wei Cheng, Keelung (TW)

Correspondence Address: ROGER H. CHU, 19499 ERIC DRIVE, SARATOGA, CA, 95070, US

(73) Assignee: ACTION STAR ENTERPRISE CO., LTD., Sijhih (TW)

(21) Appl. No.: 12/533,156

(22) Filed: Jul. 31, 2009

(51) Int. Cl. H04N 5/268; H04N 7/12; G05B 15/00; G06F 13/00

(52) U.S. Cl. 348/705; 375/240.01; 700/1; 710/107; 375/E07.076; 348/E05.057

(57) ABSTRACT

A system comprises a switching device having a first port set, a second port set and a third port set, a host computer coupled to the first port set and the second port set of the switching device and a portable computer with a built-in keyboard, display screen and cursor control device coupled to the third port set of the switching device. The switching device includes a video codec unit coupled to the first port set for receiving analog video signals from the host computer and converting the analog video signals to digital video signals. The switching device further includes a signal controlling unit coupled to the video codec unit for receiving the digital video signals, the second port set and the third port set. The signal controlling unit transmits the digital video signals to the portable computer through the third port set for displaying the digital video signals on the display screen of the portable computer. The signal controlling unit receives controlling signals from the keyboard and cursor control device of the portable computer through the third port set and transmits the controlling signals to the host computer through the second port set.

### BACKGROUND OF THE INVENTION

(a) Field of the Invention

The present invention relates to a system for controlling one host computer by another host computer, and more particularly, to a system for controlling at least one host computer by a portable computer.

(b) Description of the Prior Art

There exist devices for interconnecting a keyboard, a display screen and a cursor control device to multiple computers. For example, a keyboard/video/mouse (KVM) switch is a device that is generally connected to multiple computers in order to enable the keyboard, display screen and cursor control device to control each of the connected computers. In this way, a user may have access to multiple computers without having to invest in corresponding keyboards, display screens, and cursor control devices for each of the computers. While the user accesses a computer connected to the KVM switch, video signals are routed from the computer, processed, and displayed on the single display screen.

However, for a user having a portable computer speaking, the KVM switch aforementioned can not electrically connected to the portable computer for controlling multiple computers connected to the KVM switch by the keyboard, display screen and cursor control device built in the portable computer. On the other words, the user can not control the multiple computers by his/her own portable computer.

It is desirable, therefore, to provide a system that has an intuitive user interface to allow for easy interaction with one or more computers and a portable computer connected and allow for enabling a single user to control one or more computers by way of a keyboard, display screen and cursor control device built in the portable computer.

### SUMMARY OF THE INVENTION

It is an object of the present invention to enable a single user to control plurality of host computers by a keyboard, cursor control device and display screen built in a portable computer.

According to a preferred embodiment, the present invention provides a system comprising a switching device having a first port set, a second port set and a third port set, a host computer coupled to the first port set and the second port set of the switching device and a portable computer with a built-in keyboard, display screen and cursor control device coupled to the third port set of the switching device; wherein the switching device includes a video codec unit coupled to the first port set for receiving analog video signals from the host computer and converting the analog video signals to digital video signals; and a signal controlling unit coupled to the video codec unit for receiving the digital video signals, the second port set and the third port set; wherein the signal controlling unit transmits the digital video signals to the portable computer through the third port set for displaying the digital video signals on the display screen of the portable computer; wherein the signal controlling unit receives controlling signals from the keyboard and cursor control device of the portable computer through the third port set and transmits the controlling signals to the host computer through the second port set.

The details and technology of the present invention are described below with reference to the accompanying drawings:

### BRIEF DESCRIPTION OF THE DRAWINGS

FIG. 1 is a block diagram showing an exemplary system according to the invention.

FIG. 2 is a block diagram of one embodiment of the switching device according to the invention.

FIG. 3 is a block diagram of another embodiment of the switching device according to the invention.

FIG. 4 is a block diagram of another yet embodiment of the switching device according to the invention.

FIG. 5 is a block diagram of still another embodiment of the switching device according to the invention.

FIG. 6 is a block diagram of further embodiment of the switching device according to the invention.

FIG. 7 is a block diagram of further yet embodiment of the switching device according to the invention.

### DETAILED DESCRIPTION OF THE PREFERRED EMBODIMENTS

The present invention is similar to a system for electrically interconnecting two computers and enabling a single user to control one of the computers by the other computer. The concept is used in the system of present invention.

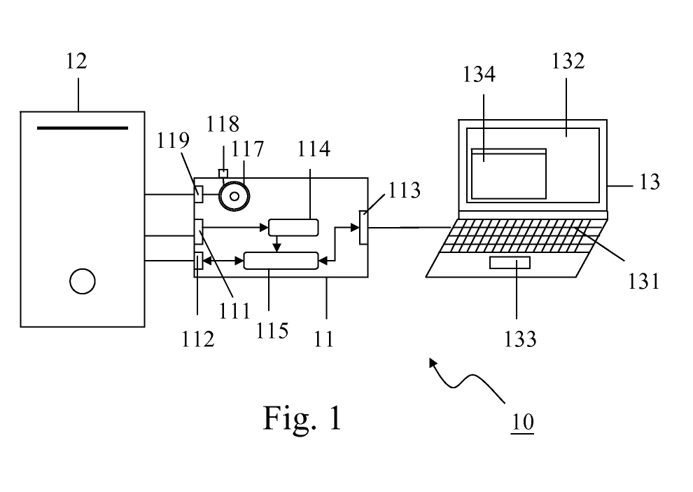

As shown in FIG. 1, the system 10 comprises a switching device 11 having a first port set 111, a second port set 112 and a third port set 113, a host computer 12 coupled to the first port set 111 and the second port set 112 of the switching device 11 and a portable computer 13 with a built-in keyboard 131, display screen 132 and cursor control device 133 coupled to the third port set 113 of the switching device 11. The switching device 11 includes a video codec unit 114 coupled to the first port set 111 for receiving analog video signals from the host computer 12 and converting the analog video signals to digital video signals. The switching device 11 further includes a signal controlling unit 115 coupled to the video codec unit 114 for receiving the digital video signals. The signal controlling unit 115 is also coupled to the second port set 112 and the third port set 113. The signal controlling unit 115 transmits the digital video signals converted from the video codec unit 114 to the portable computer 13 through the third port set 113 for displaying the digital video signals on the display screen 132 of the portable computer 13.

The portable computer 13 generates a control window 134 on the display screen 132 after receiving the digital video signals for displaying the digital video signals. The signal controlling unit 115 receives controlling signals from the keyboard 131 and cursor control device 133 of the portable computer 13 through the third port set 113 and transmits the controlling signals to the host computer 12 through the second port set 112. Thus, the host computer can be booted normally after receiving the controlling signals from the keyboard 131 and cursor control device 133 of the portable computer 13 through the third port set 113.

After electrically connecting the host computer 12 and the portable computer 13 through the switching device 12, users can control the host computer 12 by his/her own portable computer without preparing a set of keyboard, display screen and cursor control device. Moreover, if the switching device 11 further comprises a plurality of port sets for coupling to a plurality host computers, users can control the host computers by his/her own portable computer accordingly.

Moreover, the third port set 113 is an USB interface for electrically connecting to the portable computer 13. The signal controlling unit 115 can be an USB controller for converting the digital video signals to USB compatible video signals. Thus, the USB compatible signals can be transmitted to the portable computer 13 through the third port set 113 and displayed on the display screen 132 of the portable computer 13. The second port set 112 is an USB interface for electrically connecting to the host computer 12. The controlling signals from the keyboard 131 and cursor control device 133 can be transmitted from the third port set 113 (USB interface), the signal controlling unit 115 (USB controller) and the second port set 112 (USB interface) to the host computer 12.

Furthermore, the signal controlling unit 115 includes a buffer memory (not shown) for temporary storing documents in the host computer 12 and then transferring to the portable computer 13. The first port set 111 of the switching device 11 can be an interface selected from DVI, HDMI, D-sub, S-video interfaces.

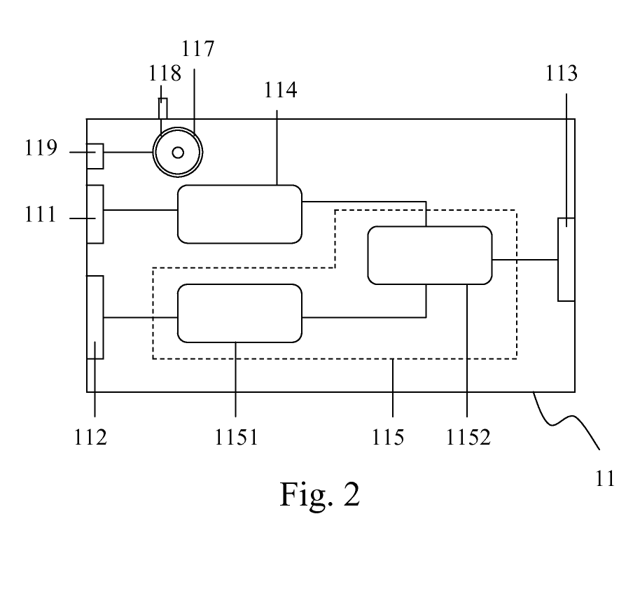

As shown in FIG. 2, a block diagram of one embodiment of the switching device 11 in FIG. 1 is presented. The signal controlling unit 115 has an USB HID (human interface) 1151 coupled to the second port set 112 and an USB controller 1152 coupled to the third port set 113, the video codec unit 114 and the USB HID (human interface) 1151 while the second port set 112 and the third port set 113 are USB interfaces. The USB controller 1152 converts the digital video signals to USB compatible video signals.

The controlling signals from the keyboard 131 (shown in FIG. 1) and cursor control device 133 (shown in FIG. 1) can be transmitted from the third port set 113 (USB interface), the USB controller 1152, the USB HID (human interface) 1151 and the second port set 112 (USB interface) to the host computer 12. The USB HID (human interface) 1151 is used to declare the host computer 12 bootable. The host computer 12 meets a minimum adherence to a basic protocol and will be recognized by BIOS of the host computer 12. On the other hand, the host computer 12 can be booted normally after the receiving the controlling signals from the USB HID (human interface) 1151.

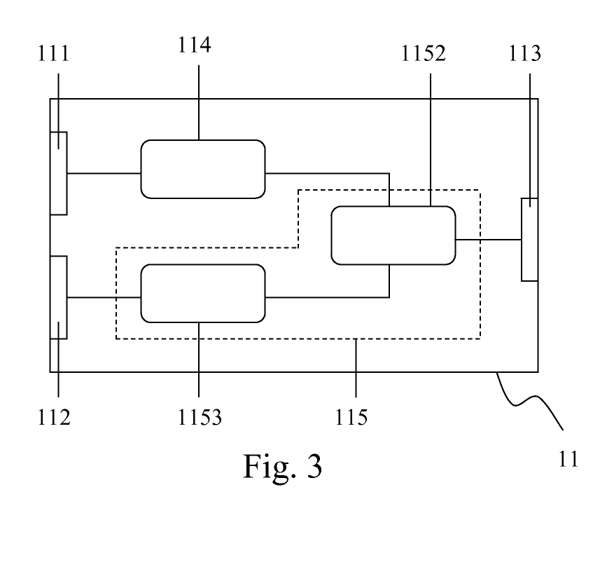

As shown in FIG. 3, a block diagram of another embodiment of the switching device 11 in FIG. 1 is presented. The signal controlling unit 115 has a MCU (micro control unit) 1153 coupled to the second port set 112 and an USB controller 1152 coupled to the third port set 113, the video codec unit 114 and the MCU (micro control unit) 1153 while the second port set 112 comprises two PS/2 ports and the third port set 113 is an USB interface. The USB controller 1152 converts the digital video signals to USB compatible video signals.

The controlling signals from the keyboard 131 (shown in FIG. 1) and cursor control device 133 (shown in FIG. 1) can be transmitted from the third port set 113 (USB interface), the USB controller 1152, MCU (micro control unit) 1153 and the second port set 112 (two PS/2 ports) to the host computer 12. The MCU (micro control unit) 1153 is used to declare the host computer 12 bootable. The MCU (micro control unit) 1153 converts the controlling signals from the keyboard 131 and the cursor control device 133 of the portable computer 13 to PS/2 compatible signals for controlling the host computer 12. Thus, although the host computer 12 is an old-type computer with PS/2 (without USB ports) control ports for connecting to a keyboard and a cursor control device, users can still control the old-type host computer 12 by the portable computer 13 through the switching device 11 of the present invention.

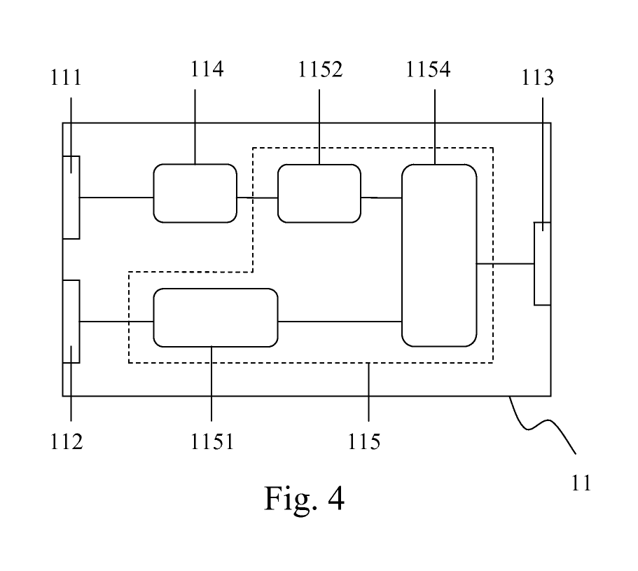

As shown in FIG. 4, a block diagram of another yet embodiment of the switching device 11 in FIG. 1 is presented. The signal controlling unit 115 has an USB HID (human interface) 1151 coupled to the second port set 112, an USB controller 1152 coupled to the video codec unit 114 and an USB hub 1154 coupled to the USB HID (human interface) 1151, the USB controller 1152 and the third port set 113 while the second port set 112 and the third port set 113 are USB interfaces.

The controlling signals from the keyboard 131 (shown in FIG. 1) and cursor control device 133 (shown in FIG. 1) can be transmitted from the third port set 113 (USB interface), the USB hub 1154, the USB HID (human interface) 1151 and the second port set 112 (USB interface) to the host computer 12. The USB HID (human interface) 1151 is used to declare the host computer 12 bootable. The host computer 12 meets a minimum adherence to a basic protocol and will be recognized by BIOS of the host computer 12. On the other hand, the host computer 12 can be booted normally after the receiving the controlling signals from the USB HID (human interface) 1151.

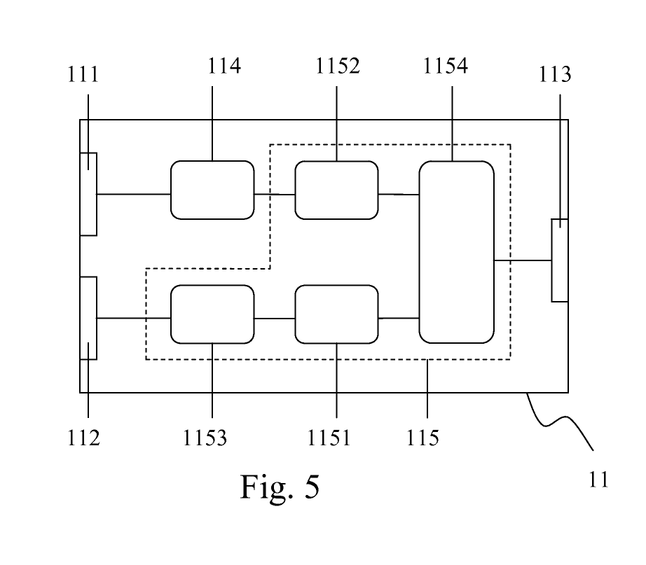

As shown in FIG. 5, a block diagram of still another embodiment of the switching device 11 in FIG. 1 is presented. The signal controlling unit 115 has a MCU (micro control unit) 1153 coupled to the second port set 112, an USB HID (human interface) 1151 coupled to the MCU (micro control unit) 1153, an USB controller 1152 coupled to the video codec unit 114 and an USB hub 1154 coupled to the USB HID (human interface) 1151, the USB controller 1152 and the third port set 113 while the second port set 112 comprises two PS/2 ports and the third port set 113 is an USB interface. The USB controller 1152 converts the digital video signals to USB compatible video signals.

The controlling signals from the keyboard 131 (shown in FIG. 1) and cursor control device 133 (shown in FIG. 1) can be transmitted from the third port set 113 (USB interface), the USB hub 1154, the USB HID (human interface) 1151, the MCU (micro control unit) 1153 and the second port set 112 (PS/2 interface) to the host computer 12. The MCU (micro control unit) 1153 is used to declare the host computer 12 bootable. The MCU (micro control unit) 1153 converts the controlling signals from the keyboard 131 and the cursor control device 133 of the portable computer 13 to PS/2 compatible signals for controlling the host computer 12. Thus, although the host computer 12 is an old-type computer with PS/2 (without USB ports) control ports for connecting to a keyboard and a cursor control device, users can still control the old-type host computer 12 by the portable computer 13 through the switching device 11 of the present invention.

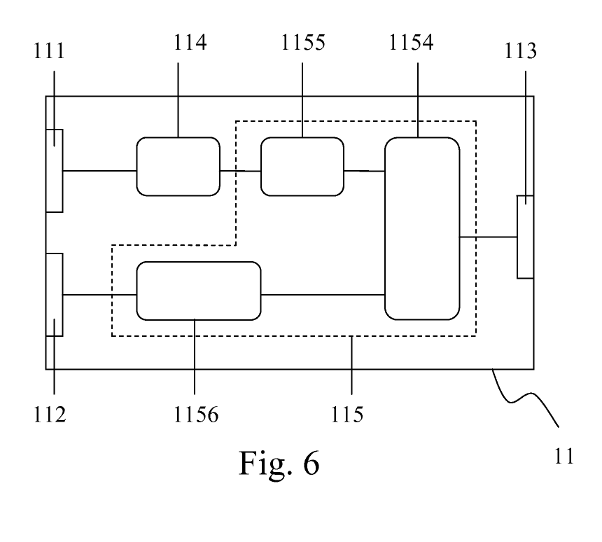

As shown in FIG. 6, a block diagram of further embodiment of the switching device 11 in FIG. 1 is presented. The signal controlling unit 115 has a first USB controller 1155 coupled to the video codec unit 114, a second USB controller 1156 coupled to the second port set 112 and an USB hub 1154 coupled to the first USB controller 1155, the second USB controller 1156 and the third port set 113 while the second port set 112 and the third port set 113 are USB interfaces. The first USB controller 1155 converts the digital video signals to USB compatible video signals.

The controlling signals from the keyboard 131 (shown in FIG. 1) and cursor control device 133 (shown in FIG. 1) can be transmitted from the third port set 113 (USB interface), the USB hub 1154, the second USB controller 1156 and the second port set 112 (USB interface) to the host computer 12. The second USB controller 1156 is used to declare the host computer 12 bootable. The host computer 12 meets a minimum adherence to a basic protocol and will be recognized by BIOS of the host computer 12. On the other hand, the host computer 12 can be booted normally after the receiving the controlling signals from the second USB controller 1156.

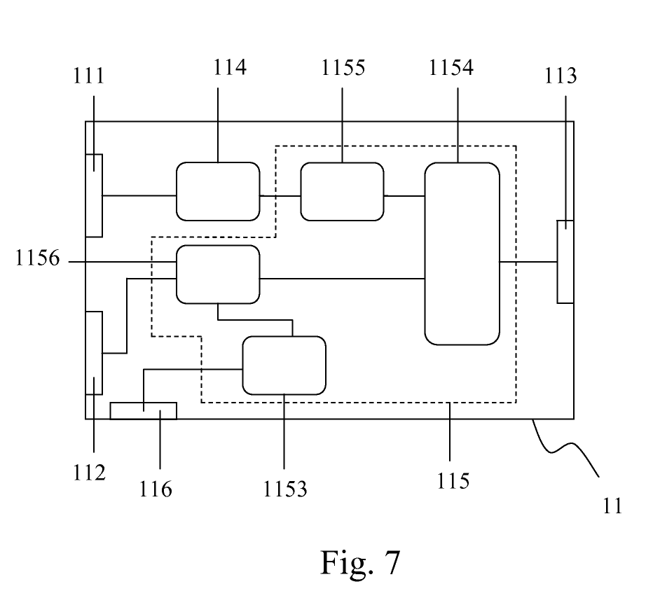

As shown in FIG. 7, a block diagram of further yet embodiment of the switching device 11 in FIG. 1 is presented. The signal controlling unit 115 has a first USB controller 1155 coupled to the video codec unit 114, a second USB controller 1156 coupled to the second port set 112 and an USB hub 1154 coupled to the first USB controller 1155, the second USB controller 1156 and the third port set 113 while the second port set 112 and the third port set 113 are USB interfaces. The signal controlling unit 115 further comprises a MCU (micro control unit) 1153 coupled between a forth port set 116 and the second USB controller 1156. The second port set 112 and the third port set 113 are USB interfaces and the forth port set 116 comprises two PS/2 ports. The first USB controller 1155 converts the digital video signals to USB compatible video signals.

The controlling signals from the keyboard 131 (shown in FIG. 1) and cursor control device 133 (shown in FIG. 1) can be transmitted from the third port set 113 (USB interface), the USB hub 1154, the second USB controller 1156 and the second port set 112 (USB interface) or the forth port set 116 (PS/2 interface) to the host computer 12. The MCU (micro control unit) 1153 converts the controlling signals from the keyboard 131 and the cursor control device 133 of the portable computer 13 to PS/2 compatible signals for controlling the host computer 12. The second USB controller 1156 is used to declare the host computer 12 bootable. The host computer 12 meets a minimum adherence to a basic protocol and will be recognized by BIOS of the host computer 12. On the other hand, the host computer 12 can be booted normally after the receiving the controlling signals from the second USB controller 1156.

Thus, no matter the host computer 12 is a new type computer with USB input interfaces or an old type computer with PS/2 input interfaces, users can control the host computer 12 by the keyboard 131, display screen 132 and cursor control device 133 of the portable computer 13 through the switching device 11 of the present invention.

Back to FIG. 1 to 6, the system 10 comprises a first cable (not shown) connected between the host computer 12 and the first port set 111 of the switching device 11 used for transmitting the analog video signal from the host computer 12 to the switching device 11. One end of the first cable can be fixed or detachable to the first port set 111 of the switching device 11; the other end of the first cable can be an interface selected from DVI, HDMI, D-sub, S-video interfaces.

The system 10 comprises a second cable (not shown) connected between the host computer 12 and the second port set 112 of the switching device 11 used for transmitting the controlling signals from the portable computer 13 to the host computer 12. One end of the second cable can be fixed or detachable to the second port set 112 of the switching device 11; the other end of the second cable can be an interface selected from PS/2 or USB interfaces.

The system 10 comprises a third cable (not shown) connected between the portable computer 13 and the third port set 113 of the switching device 11 used for transmitting all signals between the portable computer 13 and the host computer 12. One end of the third cable can be fixed or detachable to the third port set 113 of the switching device 11; the other end of the third cable can be an USB interface.

Back to FIG. 7, the system comprises a second cable (not shown) connected between the host computer 12 and the second port set 112 of the switching device 11 used for transmitting the controlling signals from the portable computer 13 to the host computer 12. One end of the second cable can be fixed or detachable to the second port set 112 of the switching device 11; the other end of the second cable is an USB interface.

The system 10 further comprises a forth cable connected between the host computer 12 and the forth port set 116 of the switching device 11 used for transmitting the controlling signals from the portable computer 13 to the host computer 12. One end of the forth cable can be fixed or detachable to the forth port set 116 of the switching device 11; the other end of the forth cable comprises two PS/2 plugs.

Back to FIG. 1 and FIG. 2, when a user controls the host computer 12 by the portable computer 13, audio signals of the host computer 13 will not be transmitted to the portable computer 13 through the switching device rendering audio signals of the host computer 13 not being broadcasted. If the user wants to broadcast audio signals of the host computer 13, he/she should prepare a cable connecting between the host computer 12 and the portable computer 13 for transmitting audio signals of the host computer 13 to the portable computer 13, and then, audio signals of the host computer 13 will be broadcasted by a speaker (not shown) built-in the portable computer 13. However, audio signals of the portable computer 13 may be also broadcasted by the speaker. The speaker built-in the portable computer 13 broadcasting both audio signals of the host computer 12 and the portable computer 13 simultaneously renders the mixed output sounds undesired. The output sounds of the speaker will be unclear and noisy.

For solving the problems above, the system 10 further comprises a fifth cable connected between the host computer 12 and a fifth port set 119 of the switching device 11 used for transmitting audio signals from the host computer 12 to the switching device 11. One end of the fifth cable can be fixed or detachable to the fifth port set 119 of the switching device 11. The switching device 11 comprises an audio broadcasting unit 117 and a switching unit 118. The switching unit 118 controls the audio broadcasting unit 117 to receive audio signals from the host computer 12 and broadcast audio signals from the host computer 12. The user can distinguish both the output sounds from the speaker built-in the portable computer 13 and the audio broadcasting unit built-in the switching device 11. Thus, the output sounds will not be unclear or noisy.

Moreover, the system 10 can only broadcast audio signals from the host computer 12 by the audio broadcasting unit 117 after disabling the speaker built-in the portable computer 13. Similarly, the system 10 can only broadcast audio signals from the portable computer 13 by the built-in speaker after disabling the audio broadcasting unit 117 switching device 11 by the switching unit 118.

Having thus described preferred embodiments of system that allows for controlling a host computer by a portable computer, it should be apparent to those skilled in the art that certain advantages of the invention have been achieved. It should also be appreciated that various modifications, adaptations, and alternative embodiments thereof may be made within the scope and spirit of the present invention. The invention is further defined by the following claims.

What is claimed is:

1. A system comprising:
a switching device having a first port set, a second port set, a third port set and a forth port set;
a host computer coupled to the first port set and the second port set of the switching device; and
a portable computer with a built-in keyboard, display screen and cursor control device coupled to the third port set of the switching device;
wherein the switching device includes:
a video codec unit coupled to the first port set for receiving analog video signals from the host computer and converting the analog video signals to digital video signals; and
a signal controlling unit coupled to the video codec unit for receiving the digital video signals, the second port set and the third port set;
wherein the signal controlling unit transmits the digital video signals to the portable computer through the third port set for displaying the digital video signals on the display screen of the portable computer;
wherein the signal controlling unit receives controlling signals from the keyboard and cursor control device of the portable computer through the third port set and transmits the controlling signals to the host computer through the second port set.

2. The system as defined in claim 1, further comprising:
a first cable connected between the host computer and the first port set of the switching device used for transmitting the analog video signal from the host computer to the switching device;
a second cable connected between the host computer and the second port set of the switching device used for transmitting the controlling signals from the portable computer to the host computer; and
a third cable connected between the portable computer and the third port set of the switching device used for transmitting all signals between the portable computer and the host computer.

3. The system as defined in claim 2, further comprising a forth cable connected between the host computer and the forth port set of the switching device used for transmitting the controlling signals from the portable computer to the host computer.

4. The system as defined in claim 2, wherein one end of the first cable can be fixed or detachable to the first port set of the switching device and the other end of the first cable can be an interface selected from DVI, HDMI, D-sub, S-video interfaces.

5. The system as defined in claim 2, wherein one end of the second cable can be fixed or detachable to the second port set of the switching device and the other end of the second cable can be an interface selected from PS/2 or USB interfaces.

6. The system as defined in claim 2, wherein one end of the third cable can be fixed or detachable to the third port set of the switching device and the other end of the third cable can be an USB interface.

7. The system as defined in claim 3, wherein one end of the forth cable can be fixed or detachable to the forth port set of the switching device and the other end of the forth cable comprises two PS/2 plugs.

8. The system as defined in claim 1, wherein the signal controlling unit has an USB HID (human interface) coupled to the second port set and an USB controller coupled to the third port set, the video codec unit and the USB HID (human interface) while the second port set and the third port set are USB interfaces, and the USB controller converts the digital video signals to USB compatible video signals.

9. The system as defined in claim 1, wherein the signal controlling unit has a MCU (micro control unit) coupled to the second port set and an USB controller coupled to the third port set, the video codec unit and the MCU (micro control unit) while the second port set comprises two PS/2 ports and the third port set is an USB interface.

10. The system as defined in claim 1, wherein the signal controlling unit has an USB HID (human interface) coupled to the second port set, an USB controller coupled to the video codec unit and an USB hub coupled to the USB HID (human interface), the USB controller and the third port set while the second port set and the third port set are USB interfaces.

11. The system as defined in claim 1, wherein the signal controlling unit has a MCU (micro control unit) coupled to the second port set, an USB HID (human interface) coupled to the MCU (micro control unit), an USB controller coupled to the video codec unit and an USB hub coupled to the USB HID (human interface), the USB controller and the third port set while the second port set comprises two PS/2 ports and the third port set is an USB interface.

12. The system as defined in claim 1, wherein the signal controlling unit has a first USB controller coupled to the video codec unit, a second USB controller coupled to the second port set and an USB hub coupled to the first USB controller, the second USB controller and the third port set while the second port set and the third port set are USB interfaces.

13. A system comprising:
a switching device having a first port set, a second port set, a third port set a forth port set;
a host computer coupled to the first port set, the second port set and the forth port set of the switching device; and
a portable computer with a built-in keyboard, display screen and cursor control device coupled to the third port set of the switching device;
wherein the switching device includes:
a video codec unit coupled to the first port set for receiving analog video signals from the host computer and converting the analog video signals to digital video signals;
a signal controlling unit coupled to the video codec unit for receiving the digital video signals, the second port set and the third port set;
an audio broadcasting unit coupled to the forth port set for receiving audio signals from the host computer and broadcasting the audio signals; and
a switching unit for enabling/disabling the audio broadcasting unit;
wherein the signal controlling unit transmits the digital video signals to the portable computer through the third port set for displaying the digital video signals on the display screen of the portable computer;
wherein the signal controlling unit receives controlling signals from the keyboard and cursor control device of the portable computer through the third port set and transmits the controlling signals to the host computer through the second port set or the forth port set.

14. The system as defined in claim 13, wherein the signal controlling unit has:
a first USB controller coupled to the video codec unit;
a second USB controller coupled to the second port set;
an USB hub coupled to the first USB controller, the second USB controller and the third port set; and
a MCU (micro control unit) coupled between a forth port set and the second controller;
wherein the second port set and the third port set are USB interfaces.

15. The system as defined in claim 13, further comprising:
a first cable connected between the host computer and the first port set of the switching device used for transmitting the analog video signal from the host computer to the switching device;
a second cable connected between the host computer and the second port set of the switching device used for transmitting the controlling signals from the portable computer to the host computer;
a third cable connected between the portable computer and the third port set of the switching device used for transmitting all signals between the portable computer and the host computer; and
a forth cable connected between the host computer and the forth port set of the switching device used for transmitting the audio signals from the portable computer to the switching device.

16. The system as defined in claim 15, wherein one end of the first cable can be fixed or detachable to the first port set of the switching device and the other end of the first cable can be an interface selected from DVI, HDMI, D-sub, S-video interfaces.

17. The system as defined in claim 15, wherein one end of the second cable can be fixed or detachable to the second port set of the switching device and the other end of the second cable is an USB interface.

18. The system as defined in claim 15, wherein one end of the third cable can be fixed or detachable to the third port set of the switching device and the other end of the third cable can be an USB interface.

19. The system as defined in claim 14, wherein the switching device further comprises a fifth port set for coupling to the host computer by a fifth cable, wherein one end of the fifth cable can be fixed or detachable to the fifth port set of the switching device and the other end of the fifth cable comprises two PS/2 plugs.
